(19) United States
(12) Patent Application Publication
(10) Pub. No.: US 2006/0019696 A1
(43) Pub. Date: Jan. 26, 2006

(54) Radio communication device and associated coupling structure comprising at least one conductor board and at least one flat antenna coupled thereto

(76) Inventors: Roman Brunel, Ulm (DE); Alexander Friederich, Aalborg (DE); Stefan Huber, Munchen (DE); Thorsten Kowalski, Munchen (DE); Martin Oelschlager, Berlin (DE); Alexandre Pinto, Kobenhavn (DK); Michael Schreiber, Aying-Goggenhofen (DE); Stefan Siebinger, Gunzburg (DE)

Correspondence Address: BELL, BOYD & LLOYD, LLC, P. O. BOX 1135, CHICAGO, IL, 60690-1135, US

(21) Appl. No.: 10/532,012

(22) PCT Filed: Oct. 16, 2003
(86) PCT No.: PCT/DE03/03435

§ 371 Date: Apr. 20, 2005

(30) Foreign Application Priority Data
Oct. 22, 2002 (DE) 102 49 221.2
Sep. 29, 2003 (DE) 103 45 230.3

(51) Int. Cl. H04Q 7/20

(52) U.S. Cl. 455/550.1; 455/556.1; 455/557

(57) ABSTRACT

A radio communication device is provided which includes a conductor board and a flat antenna disposed in the housing thereof and arranged at a distance from each other, thereby forming a coupling structure. A coupling area with a predetermined antenna volume is contained in the coupling structure between the antenna and the conductor board. At least one camera is arranged in, or adjacent to, the coupling area of the coupling structure such that they simultaneously form a component of the antenna volume of the coupling structure.

### BACKGROUND OF THE INVENTION

The present invention relates to a radio communication device and associated coupling structure having at least one circuit board and at least one flat antenna in its housing which are arranged at a distance from each other, thereby forming a coupling structure, with a coupling area having a specifiable antenna volume being enclosed between the flat antenna and the circuit board.

The trend with radio communication devices, especially mobile communication devices, is towards ever smaller models boasting ever more components and service features. Thus, in addition to the functional components such as display, keyboard, high-frequency module, baseband unit, etc., there also may be a flat antenna integrated into the housing of a radio communication device to mechanically protect the antenna. In this case, a specific volume of space is occupied which is also necessary between the flat antenna and the circuit board to enable a radio field to be transmitted or received correctly. If there is also a requirement for fitting a camera into such a communication device, further space would be required within its housing which would not be available there as a result of the high packing densities of functional components. The only possible way of accommodating the camera would be by increasing the dimensions of the housing, which would make the device unattractive.

### SUMMARY OF THE INVENTION

Accordingly, the present invention is directed toward a radio communication device with the most compact housing possible, in which at least one flat antenna and also at least one camera can be accommodated. Such may be achieved by a radio communication device of the type mentioned at the start, by arranging at least one camera in or on the coupling area such that it simultaneously forms a component of the antenna volume of the coupling structure.

The coupling area which is available and required in any event between the circuit board and the flat antenna coupled to it transmitting and/or receiving the radio fields thus will be utilized partly or completely by the camera so that, overall, an largely densely packed or compact, space-saving coupling unit consisting of a circuit board, a flat antenna and a camera is produced. Since the camera is partly or completely a component of the existing antenna volume of the coupling structure, the original housing dimensions of the radio communication device without the camera can be retained even after the additional camera has been installed or even can be reduced. The additional installation of the camera in or on the coupling area of the coupling structure causes hardly any or no antenna volume of the coupling structure to be lost so that radio fields can be sent and/or received without any problem. This dual utilization of the coupling area, in particular, allows shorter designs of the housing to be used for the radio communication device.

The present invention also relates to a coupling structure consisting of at least one circuit board and at least one flat antenna at a distance from it for a radio communication device in which case a coupling area is connected between the antenna and the circuit board with a specified antenna volume which is characterized in that at least one camera component of a camera is arranged in or on the coupling area of the coupling structure in such a way that it simultaneously forms a component of the antenna volume.

Additional features and advantages of the present invention are described in, and will be apparent from, the following Detailed Description of the Invention and the Figures.

### BRIEF DESCRIPTION OF THE FIGURES

FIG. 1 shows a schematic lengthwise sectional view from a long side of the layout of a first exemplary embodiment of a radio communication device in accordance with the present invention, in which a camera is additionally accommodated in the coupling area between its flat antenna and its circuit board as a component of the antenna volume included there.

FIG. 2 shows a schematic view from above the coupling structure consisting of the circuit board and the flat antenna coupled to it of the radio communication device of FIG. 1 which allows space-saving accommodation of the additional camera in its coupling area.

FIG. 3 shows a schematic lengthwise section of the layout of the camera in the housing of the radio communication device of FIG. 1.

FIGS. 4 and 5 show schematic diagrams of each of two variants for accommodating the camera in the coupling area of the coupling structure of FIG. 1.

FIG. 6 shows a schematic perspective diagram of a further exemplary embodiment of a radio communication device in accordance with the present invention with an integrated flat antenna and an additional integrated camera which is accommodated in a cutout of the coupling structure consisting of a circuit board and a flat antenna coupled to it.

FIGS. 7, 8 shows a schematic views from above, in each case, of two further coupling structures consisting of a circuit board and a flat antenna coupled to it which also allow a space-saving accommodation of an additional camera in a cutout running through from the front to the rear in the housing of the radio communication device of FIG. 6.

FIG. 9 shows a schematic view from above of a further modification of the coupling structure of Figure t.

### DETAILED DESCRIPTION OF THE INVENTION

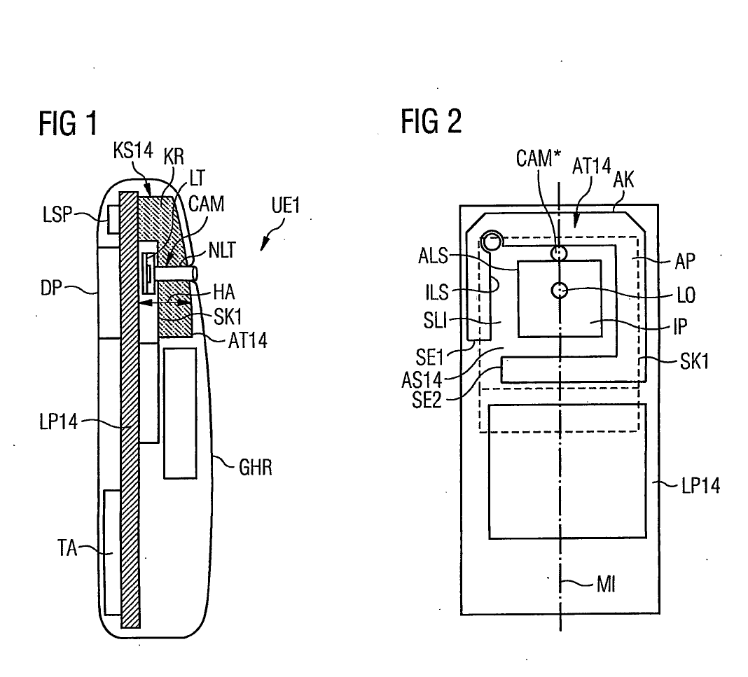

FIG. 1 shows a schematic diagram of a lengthwise section seen from one side of a first radio communication device UE1. This radio communication device UE1 features in its housing GHR a circuit board LP14 to which a flat antenna RT14 is coupled, forming a coupling structure KS14. This flat antenna AT14 integrated into the housing GHR is arranged at a distance EA to the component mounting surface of the circuit board LP14. It is assigned here to the back of the circuit board LP14; i.e., which is the bits of the circuit board which are opposite the operation components such as the loudspeaker/microphone unit LSP, display or screen device DP, or keyboard. In this way, the flat antenna AT14 is held away from the user's head if the radio communication device UE1 is used in accordance with specifications and emits its radio waves largely freely in the space and receives radio fields largely freely as well. The flat antenna AT14 is positioned in the upper half of the circuit board LP14 and is linked electrically in the area of the upper wide side of the board to the latter for power feed. It is held at a distance above the back of the circuit board LP14 as a layer so that its imaginary orthogonal projection onto the component mounting surface of the circuit board LP14 essentially lies within a delimiting surface enclosed within its sides. In this way a coupling area KR with a specified antenna volume is enclosed between the circuit board LP14 and its coupled flat antenna AT14. A suitable antenna volume serves the purpose of enabling electromagnetic fields to be formed between the flat antenna AT14 and the circuit board. Only if a specific minimum volume can be maintained is it possible to largely ensure that radio signals can be sent and/or received correctly. Depending on the form, type and other geometrical characteristics of the coupling structure including the circuit board and the flat antenna, this antenna volume of the coupling area is set specifically. For example, a lessening of the antenna volume would be accompanied by a reduction in the radiation power of the antenna.

Yet, a camera CAM is accommodated at least partly in the coupling area KR of the coupling structure KS14 of FIG. 1. To avoid reducing the usable antenna volume in the coupling area KR, only its electromagnetically-insensitive camera component NLT is arranged in the coupling area KR of the coupling structure KS14. This electromagnetically-insensitive camera component NLT is essentially formed by the optics and by the optics mounting of the camera. This is because an electrically non-conducting material, particularly a high-frequency material with a small dielectric constant and low RF loss factor, is used for this.

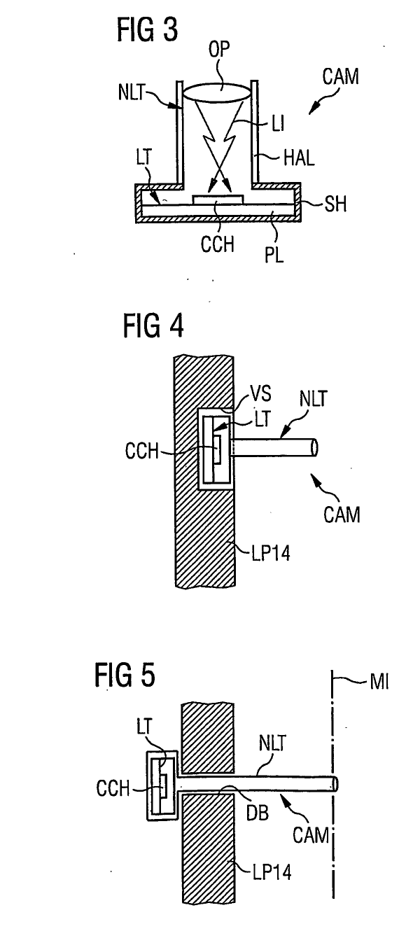

The main components of the camera CAM are shown in a lengthwise schematic diagram in FIG. 3. Here, a taking optic, particularly a camera objective or a camera lens, is accommodated at the opposite end of a circular cylinder-shaped holder HAL. Light rays LI which pass through the camera optics OP from outside are directed along the length of the holder HAL and below the holder HAL fall onto the sensor of a camera chip arranged aligned in relation to the entry opening. This converts the light rays LI into electrical signals. In particular, what is known as a CCD (Charge Coupled Device) element is used as the sensor. The camera chip CCH sits on a circuit board PL which features further electrical modules for processing the electrical evaluation signals for the image information. The electrical circuit board PL with the camera chip CCH mounted on it is accommodated in a kind of foot SH on the side of the holder HAL facing away from the optics OP. This mounting SH forms a mounting chamber for the circuit board PL with the camera chip CCH sitting thereupon. Here, in the exemplary embodiment, it is essentially embodied as rectangle. The holder HAL extends at right angles to the upper side of this mounting SH and makes a largely tight-fitting seal with the cover of the mounting device SH. The camera chip CCH and the circuit board PL with the electronics for activating and operating the camera chip CCH are operated at high clock speeds, particularly in the Megahertz range. Therefore, they form the electromagnetically-sensitive camera components LT of the camera CAM. To avoid, where possible, any interfering interactions between the electrical signals of this camera component LT and the electromagnetic fields in the coupling area KR of the coupling structure KS14, the mounting SH of the camera is accommodated in an electromagnetic screening chamber SK1. This is, in particular, the electromagnetic screening chamber for the high-frequency module of the circuit board LP14 which is present in any event. To accommodate the electrically-conducting components in the screening chamber SK1, a hole or an opening is provided in its cover, into which the end of the optics holder HAL opposite to the optics is introduced. Since the optics as well as their optics holder HAL are essentially made of non-conducting material, they can remain in the coupling area KR without unnecessarily affecting the originally usable antenna volume, or even reducing it. The electromagnetically-insensitive camera components NLT consisting of the optics OP and their optics holder HAL thus simultaneously form a component of the antenna volume of the coupling structure KS14 since they are largely “invisible” in the high frequency range for the electromagnetic fields of the antenna AT14. Because of their non-conducting characteristics, a short circuit between these electromagnetically-insensitive camera components NLT and the electrically-conducting screening chamber SK1 at the point of entry (i.e., where the electromagnetically-insensitive camera component NLT is pushed through the cover of the screening chamber SK1) is largely avoided. This is because the optics holder HAL makes electrically non-conducting contact with the inner wall of the opening in the electrically-conducting screening chamber SK1. The fact that the electrically-conducting parts of the camera CAM are arranged outside the coupling area KR electromagnetically screened, and only the electromagnetically-insensitive parts of the camera CAM are accommodated in the coupling area KR, results in adverse influences of the electromagnetic coupling field between the flat antenna AT14 and the circuit board LP14 are largely avoided. As such, there is hardly any electromagnetic absorption or no absorption of electromagnetic radiation of the antenna AT14 on account of the camera components NLT additionally introduced into the coupling area KR.

In addition to or independently of accommodating the electrically-sensitive camera components LT in the screening chamber SK1, it also may be worthwhile to embody the foot-shaped mounting chamber SH of the camera CAM itself as electromagnetic screening. Then, the camera CAM may be accommodated entirely in the coupling area KR of the coupling structure KS14.

It can be particularly advantageous to sink the electromagnetically-sensitive camera components LT into a cutout in the circuit board LP14. This is shown schematically in FIG. 4. Here, the foot-type mounting chamber SH for the electromagnetically-sensitive camera components LT sits in the cutout or the groove VS of the circuit board LP14. By integrating the electromagnetically-sensitive camera components in the wall of circuit board LP14, the part of the camera CAM which projects freely upwards can be reduced or shortened. This is preferably formed by the electromagnetically insensitive camera optics or by their holder. As such, the camera CAM also may be accommodated in a lower-profile housing with a smaller component height. With normal circuit boards, particularly the part of the camera CAM projecting freely into the coupling area KR can be reduced by between 0.6 and 14 mm.

It also may be advantageous to arrange the electromagnetically-sensitive camera components on the opposite side of the circuit board to the flat antenna outside the coupling area of the coupling structure. This is illustrated in FIG. 5. Here, the camera CAM is guided through an opening or a hole drilled in circuit board LP14 with its electromagnetically insensitive optic holder to a point where its electromagnetically-sensitive camera components LT lie on the component mounting side of the circuit board LP14 opposite to the antenna AT14. The electrically-conductive circuit board LP14 operates here to a certain extent as electromagnetic screening for the camera components LT. By this complete feeding through of the electromagnetically-sensitive camera components LT to the other side (front) of the circuit board LP14, the electromagnetically insensitive camera components protruding into the coupling area KR can be further reduced in height compared to the arrangement of FIG. 4. This allows particularly low-profile forms of housing. This is because the camera CAM only protrudes with its electromagnetically insensitive camera components NLT into the coupling area KR by a shorter section compared to the arrangement in FIG. 1.

FIG. 2 shows a schematic view from above the coupling structure KS14 of FIG. 1. The circuit board LP14 is essentially embodied as a rectangle. In its upper half in the area of its top front face, the flat antenna AT14 is arranged. It is preferably embodied as what is known as a PIFA (Planar-Inverted F Antenna). It features an internal part IP which is separated at least partly by a slot SLI from its outer frame part AP. The inner part IP is essentially embodied here in the exemplary embodiment from FIG. 2 as a rectangle. The outer frame part AP essentially surrounds this rectangular, flat inner part IP on all four sides up to one corner. Here, in the exemplary embodiment, the outer frame part AP features in the area of the left lower corner a cutout AS14. The slot SLI between the outer frame part AP and the inner part IP extends starting from this cutout AS14 and ends at it again. In this way, the slot of SLI is embodied as a rectangular frame which completely separates the outer frame part AP from the inner part IP. The inner part IP features an opening or a hole LO in its center underneath which the camera CAM is arranged in the coupling area. Immediately below the opening LO or in the opening LO sits the camera optics in this embodiment to enable pictures to be taken outside thereof.

As an alternative, it also may be useful to position the camera CAM in such a way relative to the level of flat antenna AT14 that it is arranged in the slot SLI between the outer frame part and the inner part IP. Here, too, it makes sense to position the camera at a point which lies essentially on the axis of symmetry or the center line MI of the circuit board LP14. This makes handling of the camera easier for the user concerned, particularly aligning the camera to a desired picture object. This further possible camera position at the level of the flat antenna AT14 from FIG. 2 is also shown in this Figure and is given the reference symbol*CAM.

If necessary it can be useful to make provisions for the camera viewed in the plane of the flat antenna AT14 in the area of a corner of the flat antenna such as in the cutout AS14. This corner area is still assigned to the coupling area KR of the antenna AT14 and provides sufficient space for the camera to be accommodated while retaining the existing housing dimensions.

It is, of course, also possible to provide a hole in the outer frame part AP of the flat antenna AT14 below which the camera CAM can be accommodated in the space KR.

It is common to all embodiments that the camera viewed in the plane of the flat antenna is arranged within an area which is limited by the outer contour AK of the outer frame part AP. As such, the coupling area which is present in any event below the flat antenna is also used as space to accommodate the camera.

Considered overall, the coupling area which is present with the specified antenna volume in the coupling structure made up of the circuit board and the flat antenna arranged at a distance from it can be used to arrange in or on the coupling area of the coupling structure at least one camera in such a way that it is simultaneously a component of the antenna volume of the coupling structure. As such, it is not necessary to increase the size of the housing for additionally accommodating the camera, especially lengthening the housing or making it wider. Instead, an integrated overall structure of circuit board, flat antenna and camera built in between them is formed which allows dual use of the existing antenna volume. The first use of the coupling area is the formation of an electromagnetic coupling field between the flat antenna and the circuit board. The second use is the additional accommodation of the camera. Because of the extremely compact overall structure, this then gives optimal freedom in designing the housing of the radio communication device while simultaneously maintaining the antenna function.

It is thus of advantage for the camera to be positioned in the center of the antenna volume. This utilizes the effect that the entire optics of the camera is constructed from electrically non-conducting materials which merely feature small RF losses and a small dialectic constant. The entire volume for the optics of the camera thus can be simultaneously used by the antenna. Therefore, camera position has a greater degree of freedom and, for reasons of symmetry, can lie in the center or on the axis of symmetry of the circuit board even through this volume is used for the antenna.

Simultaneously, a screening of the EMF-sensitive areas of the camera with a screening chamber makes sense. For cameras with a large focal length it is also possible to position the camera chip between the circuit board and the display (cf. FIG. 5). In this case, a hole is provided in the circuit board and the required point for the optics. With this layout concept the camera chip is also subjected to significantly lower field strengths than in the coupling area underneath the antenna, so that it may be possible to dispense with electromagnetic screening of the electrically-conductive parts of the camera. In the antenna, which consists of electrically-conductive materials such as, for example, flat metal parts, a small hole is provided at the appropriate point for the optics of the camera. In this case, the effect is additionally exploited that electrically small holes in the flat structure of the circuit board largely leave its antenna characteristics unchanged. Expressed in another way, a comparatively small drilled hole in relation to the overall surface of the antenna does not influence, or only barely influences, the electromagnetic radiation and receive characteristics of the antenna. Preferably, the hole diameter lies between 5 mm and 9 mm for a board with a length off 40 mm and width of 24 mm. The fact that the integrated camera is basically subdivided into an electrically-conducting camera part and an electromagnetically-insensitive camera part allows the electromagnetically-insensitive camera part to be positioned in the antenna volume itself and the electrically-conducting camera part outside the antenna volume. The electromagnetically-insensitive camera part is preferably formed by the camera optics as well as their holder. The appropriate high-frequency materials are suitable for this which are low-loss and electrically non-conductive as well as additionally featuring a small dielectric constant. As such, electromagnetic losses as a result of the camera additionally being placed in the antenna volume are largely avoided. In addition, it is possible to protect the sensitive electronic parts of the camera with a screening chamber.

This integrative overall structure of flat antenna, circuit board and camera inserted between them allows a further miniaturization of the housing for a radio communications device to be achieved. In particular, special low-profile designs for the housing of a radio communication device are made possible.

An advantageous further embodiment relates to a radio communication device with at least one circuit board and at least one flat antenna which is coupled to the circuit board forming a coupling structure to transmit and/or receive electromagnetic radio fields.

For a radio communication device with a flat or planar antenna accommodated in its housing (known as a “patch antenna”), this flat antenna is arranged above the circuit board of the radio communications device at a specified distance and covers a part of the surface of the circuit board like a layer. With a conventional mobile radio device such patch antennas, particularly dual or tri-band-capable planar antennas, are typically integrated into the upper half of the circuit board. Because of the specified compact dimensions of such a mobile radio device, it is therefore difficult to also accommodate a camera, particularly a digital camera, in its housing. This is because such a camera requires space in the radio communication device because of its size and mechanical requirements made on its camera housing.

The particular problem which presents itself is to provide a radio communication device in the housing of which a camera can be additionally accommodated while largely retaining the original housing dimensions of the radio communication device. This problem is preferably resolved by a radio communication device in which the coupling structure made up of the circuit board and the coupled flat antenna features a cutout passing through from its front side to its rear side into which a camera is integrated.

Its taking optics advantageously may be moved to and fro between the front and rear side of the coupling structure.

This allows a radio communication device with compact housing dimensions to be provided in which both at least one flat antenna and a camera are integrated. In particular the cutout or indentation in the relevant coupling structure made up of circuit board and coupled flat antenna allows the camera to be accommodated in the housing of the relevant radio communication device in such a way that its taking optics can be rotated to and fro between the front and rear side of the housing, particularly through 180° from front to back (and vice-versa). This simultaneously largely avoids the undesired effect of making the device any thicker because of the additional camera, since because of the cutout through from the front to the rear of the coupling structure (i.e., both in the circuit board and in the flat antenna coupled to it) the entire overall depth or overall thickness of the housing is available as free space for accommodating the camera. This allows radio devices with lower-profile forms of housing, i.e. thinner devices.

A further embodiment relates to a coupling structure consisting of at least one circuit board and at least one flat antenna coupled to it at a distance for a radio communication device, where the coupling structure features a cutout penetrating from the front to the rear into which a camera is integrated such that the taking optics can be moved to and fro between the front and the rear.

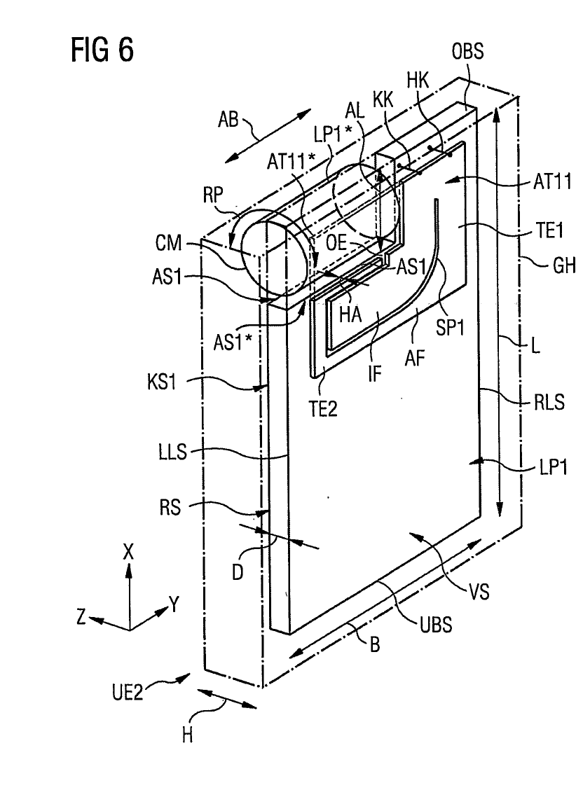

FIG. 6 shows an example in a schematic diagram in a perspective representation of a first radio communication device UE. This radio communication device UE features within its housing GH a circuit board LP1 and a flat antenna AT11 which is coupled to the circuit board LP 1 to form a coupling structure KS1 for transmitting and/or receiving electromagnetic radio fields. In this diagram, the housing GH is merely indicated by a dotted outer contour to allow a good view into the inside of the radio communication device UE. The housing GH essentially has a flat cuboid form; i.e., viewed from the front or the rear it is essentially rectangular in shape. The circuit board LP1 is accordingly embodied in accordance with the rectangular inner space of the housing GH in a first approximation also as a flat rectangle. In FIG. 6, the outline of such a flat rectangular circuit board is shown as a dotted line and is given the reference symbol LP1*. Its dimensions with regard to maximum length L and maximum width B largely correspond to those of the rectangular internal space of the housing GH. Its thickness D is also dimensioned such that the overall height of circuit board and the one or more transmit or receive antennas coupled to it is the same as the height H of the housing GH. On the circuit board, in this case, a number of electrical components for transmitting and/or receiving radio signals, such as a high-frequency module, a power supply module (for example, a battery or a rechargeable cell), input and/or output units (for example, a keyboard, a display, a loudspeaker, etc.) control and signal processing modules for radio signals to be received and/or transmitted can be accommodated. These equipping modules are not shown on the circuit board in FIG. 6 in order to simplify the drawing. In practice, the dimensions of the circuit board (i.e., its length, width and thickness) are thus essentially limited by the desired geometrical shape of the housing.

Viewed in simple terms, the circuit board LP1 of FIG. 6 has four edges LLS, OBS, RLS, UBS, with the two long edges LLS, RLS basically running at right angles to the wide edges OBS, UBS. Taken together, except for a gap AS1 in the area of the top left corner of FIG. 6 (i.e., in the area of the intersection point of the upper wide side OBS and the left long side LLS) they form the outer contour of a rectangle. Their dimensions (i.e., their length L and width B) are preferably chosen so that the length L is greater than the width B. Their perspective geometrical relationships are illustrated in FIG. 6 which additionally shows the coordinates X, Y, Z of a Cartesian co-ordinate system. In FIG. 6, the X co-ordinate extends along the long sides LLS, RLS of the circuit board LP1 while the Y direction runs in parallel to the wide sides OBS, UBS of the circuit board LP1. The component mounting surface of the circuit board LP1 thus lies essentially in the X-Y plane. The Z direction is, in this case, assigned to the height or thickness of the circuit board LP1 with its various components; for example, the high-frequency module, input/output units, control modules, evaluation modules, etc.

So that despite the limited, fixed amount of space offered within the interior of the housing GH in addition to the coupling structure including a circuit board and the antenna coupled to it, a camera CM can be accommodated inside the housing GH while retaining the previous dimensions, there is a cutout made in the coupling structure of circuit board and the flat antenna coupled to it which extends from the front to the rear. The cutout in the circuit board LP1 is designated in this diagram as AS1. In the present exemplary embodiment, the cutout AS1 extending from the front VS to the rear RS of the coupling structure in the circuit board LP1 is provided in the corner area between the left long side LLS and its upper side or wide side OBS (when looking in the Z direction on the front side VS). The cutout or the section removed AS1 is thus open on two sides upwards when viewed in the X-Y plane. It is essentially embodied in the form of a rectangle, so that a type of rectangular chamber is formed for mounting the camera CM. Naturally, an appropriate opening or cutout is also provided in the housing for the camera.

In the radio communication device UE, the flat antenna AT11 coupled in a layer over the circuit board LP1 also features a corresponding rectangular-shaped cutout AS1* in relation to its imaginary rectangular basic form in the left upper corner area of the coupling structure KS1, largely congruent (i.e., covering the same area) as the cutout AS1 of circuit board LP1. The original basic rectangular form of the flat antenna AT11 is shown in FIG. 6 and is designated by the reference symbol AT11*. Viewed from above and the front it also overlaps this left corner area of the originally rectangular circuit board LP1. The coupling structure KS1 is thus made up of the overlaying of the originally rectangular circuit board LP1* and the parallel-layer-type, rectangular antenna AT11* coupled to it at a distance HA. In this case, viewed in the Z direction on the front VS—their common left corner area is cut out like a rectangular window.

The flat antenna AT11 equipped with the rectangular cutout AS1* is arranged in FIG. 6 in the area of the upper side OBS of circuit board LP1 at a specified distance HA from the component mounting surface of the circuit board LP1 as a further layer. It is preferable to select a distance of between 4 mm and 11 mm. In this case, it extends basically in parallel to the component mounting surface of the circuit board LP1. It is aligned in relation to the circuit board in such a way that the outer edges in an imagined right-angle projection onto the component mounting surface of circuit board LP1 lie essentially congruently to the sides LLS, OBS RLS, UBS of the circuit board LP1*. In other word, the flat antenna AT11 does not protrude beyond the four sides of the component mounting surface of the circuit board LP1. The flat antenna AT11 thus lies as a further overlapping layer above the plane of the circuit board LP1 within the area delimited by its four sides, which advantageously allows a complete coupling structure and thus low-profile device designs to be implemented.

The flat antenna AT1 thus surrounds the rectangular cutout AS1 of the circuit board LP1 in the form of an L-profile because of its cutout AS1* which covers the same area. Expressed in general terms, it is derived from the imaginary rectangular basic antenna form AT11* that, in a corner area between a long side and a wide side, it features a rectangular-shaped cutout AS1*, open upwards, below which the cutout of the circuit board covering approximately the same area lies In this way, the L-shaped profile of the antenna AT11 is made up of a first, rectangular strip element TE1 running in the X lengthwise direction as well as a second rectangular strip element TE1 running at right angles to it in the Y direction. The second strip element connects the frame or ground or the cutout AS1 of the circuit board LP1 at least in a part section in the Y direction. Here, in the exemplary embodiment of FIG. 6, the first strip element of the L-shaped antenna AT11 thus forms a right-hand frame part of the cutout AS1 provided in the left-hand corner area of the circuit board LP1.

The flat antenna AT11 is connected to the board via what is known as a “hot lead” KK (i.e., via a mechanical and electrical contact in the area of the upper side OBS of the circuit board LP1) and obtains electrical energy from there for radiating electromagnetic radio waves or forwards received energy from radio waves to the main module on the circuit board. At the same time, the antenna AT11 is connected at a further point, displaced from the hot lead KK in the Y direction, to what is known as a cold lead RK. This connects the antenna AT11 to the chassis of the circuit board LP1. Such grounding of the flat antenna AT11 is preferably provided for what are known as λ/4 antennas. In particular, the flat antenna AT11 can be embodied as a PIFA (Planar Inverted F-Antenna).

Considered in general terms, the relevant flat antenna or patch antenna can be formed by an electrically-conducting flat element linked by electrical, capacitive and/or inductive coupling to the circuit board LP1.

In this way, the camera CM can be integrated into the cutout AS1, AS1* of the coupling structure KS1. A digital camera is preferably used for this purpose. The cutout AS1 extending through from the front VS to the rear RS of the circuit board LP1 as well as the cutout AS1* of the flat antenna AT11 allow the taking optics of the camera to be moved to and fro between the front VS and the rear RS of the housing GH in the corresponding cutouts. This rotation facility of the camera to different angles of view between the front VS and the rear RS of the radio communication device UE is indicated in FIG. 6, by a double-ended arrow RP. In FIG. 6 the camera CM is particularly embodied in the form of a cylinder, with its axis of rotation moving in the Y direction. This allows the taking optics to be rotated through almost 360°. It is at least possible to rotate its taking optics to and fro between the front VS and the rear RS of the housing GH from 0° to 180°. This allows the camera to be used flexibly both for self-portraits of the user and also to take pictures or their environment, without it being necessary to turn the device itself around; i.e., move it away from its operating position.

To enable signals to be transmitted and received in two separate frequency bands, the flat antenna AT11 features a slot SP1 which begins on the inside of the antenna surface in the center area between the power supply contacting KK and the ground contacting HK of the first strip element of the L-profile and ends at the outer edge running in the Y direction of the second strip element of the L-shaped antenna AT11 at the base of the cutout AS1* with an end open to the outside OE. The slot SP1 in this case describes an arc or, where necessary, describes one or more meandering bends or turns. In this way, the flat surface of the antenna AT11 can be subdivided to an extent so that electromagnetic waves can run along a first subsurface IF along the internal bends of the singly or multiply angled slot SP1, giving the electromagnetic waves a longer path and thus resulting in a lower resonant frequency compared to the first resonant frequency. By harmonizing the length of the slot SP1, the run length of the internal and external patches or antenna part IF, AF can be adapted to the relevant transmission frequency required. The length of the slot SP1 can be adjusted, for example, by selecting the length of the side sections TE1, TE2 of the L-shaped geometrical form of the flat antenna AT11 and/or by the appropriate angling of the slot SP1. In this way, a flat antenna AT11 with dual-band capabilities is formed. This can be provided, for example, for receiving and/or transmitting in the range of 900 MHz for GSM (Global System for Mobile Communications) as well as simultaneously in the higher frequency range of 1800 MHz for PCN (Private Communication Networks) or for UMTS (Universal Mobile Telecommunications System) radio frequency ranges.

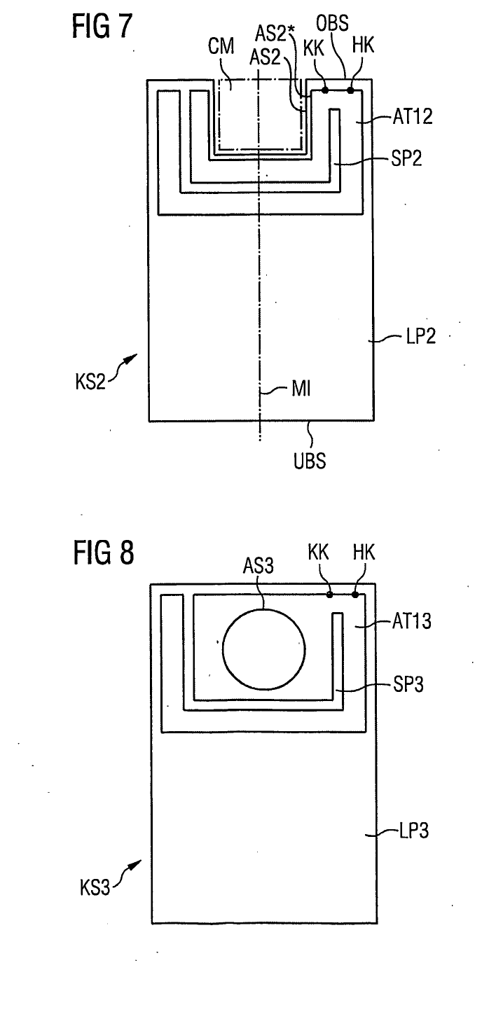

Of course, it also may be worthwhile to provide the rectangular cutout open to the outside on both sides in the coupling structure KS1 also, when viewed from above towards the front VS, in the right-hand corner area between the right long side RLS and the upper side OBS of the circuit board LP1*. The rectangular cutout AS1, AS1* in the coupling structure KS1 preferably has a width AB in the Y direction and a length AL in the X direction, which largely correspond to the dimensions of the camera CM in width and length. The width AB of the cutout in the coupling structure is preferably chosen between 1 and 3 cm, preferably around 2.5 cm. The length AL of the cutout in the coupling structure is preferably dimensioned between 1 cm and 2 cm, particularly around 1.5 cm.

Where necessary, it also may be worthwhile to make a substantially rectangular cutout open on one side upwards in the center area between the left and right along side of the circuit board and in the area up of its upper side. A coupling structure modified in this way compared to that shown in FIG. 6 is shown in simplified form from above at the front in FIG. 7 and is designated KS2. It differs from the coupling structure of the original rectangular circuit board LP1* and the originally rectangular flat antenna AT11 coupled to it in that now, instead of the cutouts AS1 and AS1* in the area of the top left corner, a coinciding rectangular cutout AS2, AS2* in the central area of the upper side of the circuit board LP is provided. The circuit board modified in this way is designated LP2 in FIG. 7. This forms a U-profile-shaped mounting chamber for the camera CM. This is embodied with regard to its internal width, asymmetrically to the dotted center line MI shown in FIG. 7 which runs through the middle of the upper and lower wide side OBS, UBS as well as in parallel to the long sides LLS, RLS of the circuit board LP2. The top of the mounting chamber is open in the area of the upper side OBS of the circuit board LP2 at its edge so that the camera CM can be accommodated there in a modular way and can be moved inwards and outwards in the X direction. This guarantees fast insertion and removal. At the same time, the same coupling structure can be used during manufacturing of radio communication devices with and without a camera, which simplifies production processes and inventory. In FIG. 7, the antenna AT12 surrounds the rectangular mounting chamber in the form of a U-profile. In other word, the flat antenna AT12 is arranged at a distance HA from the circuit board LP2 above its component mounting surface in the form of a U-profile. In the overhead profile shown in FIG. 7 (i.e., with an imaginary orthogonal projection to the component mounting surface of the circuit board LP2) the flat antenna AT12 thus covers the leg-type parts of the circuit board LP2 extending in the X direction to the left and right of the rectangular mounting chamber arranged in the center as well as a strip of the circuit port along the floor of the mounting chamber in the Y direction. The flat antenna AT12 features, like the antenna AT11, a slot SP2 which now runs in a U shape.

The fact that the mounting chamber is arranged symmetrically around the axis in the coupling structure KS2 makes it possible for the taking optics of the camera CM to be symmetrically aligned in relation to the field of view of the relevant user, which makes the camera CM simpler to operate, particularly for taking self-portraits.

If necessary it can be worthwhile providing a cutout in the inner area of the coupling structure of circuit board and flat antenna (i.e., within their common overlapping area) in the Z-direction (i.e., at right angles to the X, Y plane) such that the cutout is encircled by the flat antenna and is not, as shown in FIG. 6, freely-accessible or open at the two side edges of circuit board LP1. This is illustrated in the overhead view of FIG. 8, using a circuit board LP3 with a flat antenna AT13 coupled above it, of which the coupling structure and geometrical form largely correspond to the circuit board LP1* and the flat antenna AT11* of FIG. 6, but now features, in the common coverage area of circuit board and coupled flat antenna in the inner surface, a shared cutout AS3 extending from the front to the rear. This through opening basically has a circular geometrical form in the X, Y plane. In this case, it is completely surrounded by the flat antenna AT13. This cutout AS3 extending from the front to the rear is preferably suitable for fitting a camera which features a spherical adjustment mechanism for its taking optics. This embodiment all so makes it possible to save space when accommodating the camera while largely retaining the original dimensions of the housing GH.

This flat antenna AT13 is also embodied here like flat antennas AT11, AT12 as a dual-band antenna. To this end, it features a slot SP3 which has its starting point in its inner surface in the area of the hot and cold leads KK, HK. Such starting point in this case is displaced lengthwise in the X-direction to the two points of contact KK, HK. In detail, the slot SP3 runs along a part section of the right long side of the circuit board LP3 in the X direction to which a part running in the Y direction is connected at a 90 degree angle which subsequently again turns at a 90 degree angle and thus runs in parallel to the left long side. The slot SP3 ends here in the area of the upper side of the rectangular-shaped circuit board LP3 and is essentially axis-symmetrical to the two points of contact KK, HK.

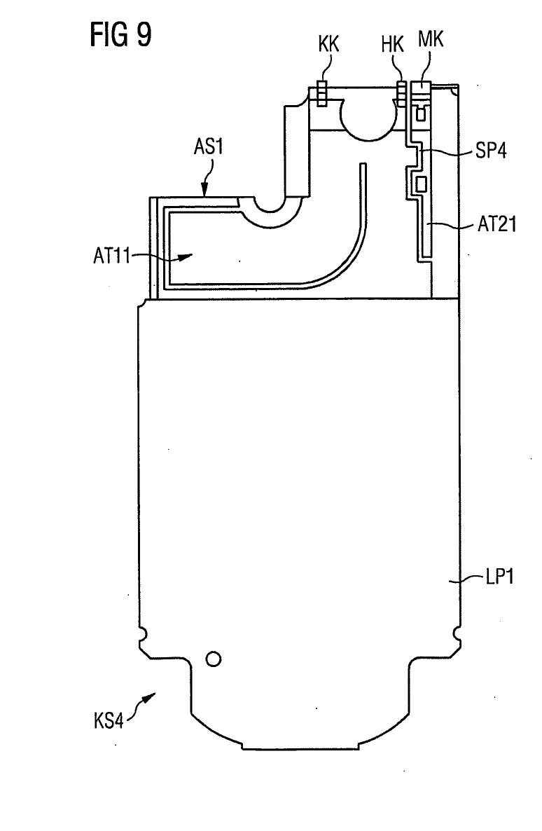

FIG. 9 shows a schematic overhead view of circuit board LP1 from FIG. 6 with the coupled flat antenna AT11, with a second flat antenna AT21 now being provided in the area of the right long side of the circuit board LP1. In order to be able to accommodate the second flat antenna AT21 in the upper area of the top half of the circuit board LP1 in addition to the first flat antenna AT11, the first flat antenna AT11 is somewhat shortened with regard to its width compared to the exemplary embodiment from FIG. 6. An end-to-end slot SP4 completely separates or isolates the second antenna AT21 from the surface of the first antenna AT11. The slot SP4 runs here from the upper side OBS of the circuit board LP1 approximately in the X direction, being routed by one or more meandering bends to the right long side and ending there. For the second antenna AT21 there is a separate point of contact MK provided to the ground of circuit board LP1. Its power is also fed starting from the hot lead via capacitive and/or inductive coupling. In this way, a tri-band antenna structure is provided, so that radio operation on three different transmit and/or receive frequencies is possible.

To summarize, a cutout made from the front to the rear in the relevant coupling structure including the circuit board and the corresponding coupled flat antenna allows a space-saving, modular integration of a camera to be provided, for which the taking optics can be rotated within a wide angle, preferably at least between 0° and 180° between the front and the rear of the device housing. This allows a single camera to be used for taking self-portraits of the user and also pictures of their environment by simply rotating its taking optics. As such, it is not necessary to have a first separate camera for pictures of the environment built into the back of the radio communication device as well as a separate second camera for self-portraits built into the front of the radio communications device. In this way, radio communications devices, particularly mobile telephones with an antenna integrated into the housing and a camera, can be implemented with a very low profile. Undesired thickening of the radio communication device by the additional integration of a camera into its housing is largely avoided. Preferably, the radio communications device with a camera integrated in this way into the coupling structure of the circuit board and antenna has a total thickness of between 11 and 25 mm. The relevant camera can be accommodated by the cutout in the coupling structure so that a number of taking angles for the taking optics of the camera can be set. In particular, the camera can at least be moved to and fro between the front and the rear of the radio communication device without the alignment or the operating position of the relevant radio communication device itself needing to be changed.

Naturally, the coupling structure in accordance with the present invention including a circuit board and antenna coupled to it with a cutout extending from the front to the rear of for an integrated camera can be used not just with mobile radio devices with a flat rectangular profile but also with sliding-case telephones, clamshell case telephones and other types and geometrical forms of mobile radio devices.

Moreover, a fixed camera also may be accommodated in the relevant cutout of the coupling structure.

Although the present invention has been described with reference to specific embodiments, those of skill in the art will recognize that changes may be made thereto without departing from the spirit and scope of the present invention as set forth in the hereafter appended claims.

1-28. (canceled)

29. A radio communication device, comprising:
a circuit board;
a flat antenna;
a housing in which the circuit board and flat antenna are positioned, wherein the circuit board and the flat antenna are arranged at a distance from each other so as to form a coupling structure, with a coupling area being enclosed in the coupling structure between the flat antenna and the circuit board which has a specifiable antenna volume; and
a camera arranged in the coupling area of the coupling structure so that the camera simultaneously forms a component of the antenna volume of the coupling structure.

30. A radio communication device as claimed in claim 29, wherein the camera features an electromagnetically-sensitive camera component and an electromagnetically-insensitive camera component.

31. A radio communication device as claimed in claim 30, wherein the electromagnetically-insensitive camera component is substantially formed by optics of the camera and by its optics mounting.

32. A radio communication device as claimed in claim 30, wherein only the electromagnetically-insensitive camera component is accommodated in the coupling area of the coupling structure.

33. A radio communication device as claimed in claim 30, wherein the electromagnetically-sensitive camera component is additionally surrounded by an electromagnetic screening.

34. A radio communication device as claimed in claim 30, wherein the electromagnetically-sensitive camera component is sunk into the circuit board.

35. A radio communication device as claimed in claim 30, wherein the electromagnetically-sensitive camera component is arranged on a side of the circuit board opposite the flat antenna outside the coupling area of the coupling structure.

36. A radio communication device as claimed in claim 29, wherein the camera is arranged with regard to its lengthwise extent substantially at right angles to a position of the circuit board and the flat antenna.

37. A radio communication device as claimed in claim 29, wherein the camera, viewed from a level of the flat antenna, is positioned in a hole-type cutout of the flat antenna and is surrounded by an antenna surface of the flat antenna.

38. A radio communication device as claimed in claim 29, wherein the camera is substantially arranged in a middle area in relation to a transverse extent of the housing.

39. A radio communication device as claimed in claim 29, wherein the flat antenna is a PIFA, of which an inner part of the PIFA is at least partly separated from an outer part of the PIFA by a slot.

40. A radio communication device as claimed in claim 39, wherein the camera, viewed from a level of the PIFA, is positioned within an area which is delimited by an outside contour of the outer part of the PIFA.

41. A radio communication device as claimed in claim 39, wherein the camera is positioned substantially in a center area of the inner part of the PIFA.

42. A radio communication device as claimed in claim 39, wherein the camera, viewed from a level of the PIFA, is arranged in the slot between the outer part and the inner part of the PIFA.

43. A radio communication device as claimed in claim 39, wherein the outer part includes a cutout in an area of a corner of the PIFA in which the camera is arranged.

44. A radio communication device as claimed in claim 29, wherein the circuit board is substantially rectangular in shape.

45. A radio communication device as claimed in claim 29, wherein the flat antenna is arranged in an area of an upper side of the circuit board.

46. A radio communication device as claimed in claim 29, wherein the flat antenna is arranged at a specifiable distance from a component mounting surface of the circuit board in at least one further layer such that its imaginary orthogonal projection in relation to the component mounting surface of the circuit board substantially lies within a restricted surface spanned by its edges.

47. A radio communication device as claimed in claim 46, wherein the flat antenna runs substantially in parallel to the component mounting surface of the circuit board so as to form a cover over an area of the component mounting surface of the circuit board.

48. A radio communication device as claimed in claim 29, wherein the flat antenna includes a slot which begins on an inside flat antenna surface and runs to an end on an outside edge of the flat antenna opening outwards.

49. A radio communication device as claimed in claim 29, wherein the coupling structure formed of the circuit board and the coupled flat antenna includes a cutout running therethrough from a front to a rear into which the camera is integrated.

50. A radio communication device as claimed in claim 49, wherein the cutout running from the front to the rear in the coupling structure is provided in a corner area between a long side and a wide side of the circuit board and features two open sides.

51. A radio communication device as claimed in claim 50, wherein the flat antenna partly surrounds the cutout of the circuit board in an L-profile form.

52. A radio communication device as claimed in claim 49, wherein the cutout running from the front to the rear in the coupling structure is provided in an enter area of an upper side of the circuit board with an open side of the cutout being at the upper side of the circuit board, and the cutout is at least partly surrounded by a flat antenna in a U-form.

53. A radio communication device as claimed in claim 49, wherein the coupling structure includes in an inner zone a circular cutout running therethrough from the front to the rear of the coupling structure to accept the camera, with the circular cutout being encircled by the flat antenna.

54. A radio communication device as claimed in claim 49, wherein the cutout is substantially rectangular in shape.

55. A radio communication device as claimed in claim 29, wherein the camera is embodied so as to be rotated such that its taking optics may be moved to and fro between the front and the rear of the coupling structure.

56. A coupling structure for a radio communication device, comprising:
a circuit board; and
a flat antenna coupled to the circuit board at a distance, with a coupling area having a specifiable antenna volume being enclosed between the flat antenna and the circuit board;
wherein a camera component of a camera is arranged in the coupling area of the coupling structure so that the camera component simultaneously forms a component of the antenna volume.
